(19) United States
(12) Patent Application Publication
(10) Pub. No.: US 2026/0316575 A1
(43) Pub. Date: Oct. 15, 2026

(54) Accident-Safe Power Electronics Unit, Drive Device Comprising Such a Unit, and Motor Vehicle Equipped Therewith

(71) Applicant: Bayerische Motoren Werke Aktiengesellschaft, Muenchen (DE)

(72) Inventor: Peter DAVISON, St. Ulrich bei Steyr (AT)

(21) Appl. No.: 19/642,756

(22) Filed: Apr. 9, 2026

(30) Foreign Application Priority Data
Apr. 10, 2025 (DE) 10 2025 114 105.3

(51) Int. Cl. B60L 3/00; B60L 15/00; H01H 39/00

(52) U.S. Cl. CPC B60L 3/0007; B60L 15/007; H01H 39/006; B60L 2210/42; B60L 2220/14; H01H 2039/008

(57) ABSTRACT

A power electronics unit includes power semiconductors for providing an AC voltage, external contacts for connecting to stator windings of a permanently excited synchronous machine which are able to be supplied with the AC voltage, and a filter circuit that is arranged at a spatial distance from the power semiconductors. The filter circuit is electrically connected between the power semiconductors and the external contacts. The filter circuit has an integrated pyrotechnic disconnect unit which is configured to physically break, within the disconnect unit, an electrical connection between the power semiconductors and the external contacts which runs through the filter circuit and the disconnect unit. Also disclosed are a drive device including such a power electronics unit and a motor vehicle including such a drive device.

### CROSS-REFERENCE TO RELATED APPLICATION

This application claims priority under 35 U.S.C. §119 from German Patent Application No. 10 2025 114 105.3, filed Apr. 10, 2025, the entire disclosure of which is herein expressly incorporated by reference.

### BACKGROUND AND SUMMARY

The present disclosure relates to a power electronics unit for a permanently excited synchronous machine and a drive device comprising such a power electronics unit. The present disclosure also relates to a motor vehicle comprising such a drive device.

Electric machines are used in many different applications and areas, for example increasingly also as drive machines for electric motor vehicles. Particularly in the case of permanently excited synchronous machines, a rotor movement which is not caused by the drive, i.e. not caused by the synchronous machine itself, and which is therefore uncontrolled, can induce a sometimes undesirable current, i.e. can generate unwanted electricity, due to the permanent magnets. To avoid this, conventional switches can be opened, for example, to interrupt a relevant current path. However, there may also be situations in which this is not possible or not fast enough. Therefore, fuses can also, or additionally, be used, for example. However, once these have tripped, repairs can be time-consuming and/or costly and may themselves carry the risk of further damage to other components.

For example, EP 3 542 437 B1 describes a protection device in a vehicle with high current and high-voltage components. It proposes that, in addition to physically disconnecting a storage battery from an HV intermediate circuit, this HV intermediate circuit is discharged via a discharge resistor. This is intended to increase safety, in particular in the event of a crash.

WO 2017/101 996 A1 describes a power electronics unit for controlling a permanent-magnet electric machine comprising a rotor and a stator having a stator winding. An overvoltage protection device is provided in that case to protect a power switch for controlling the stator winding. This protection device comprises a phase voltage detecting device assigned to the power switch and a short-circuit switching device which can be activated to short-circuit the stator winding when a predefined phase voltage threshold value is reached or exceeded. Thus, a protection device with simpler circuitry to protect against reverse voltage transfer in a permanent-magnet electric machine is intended to be provided which is suitable in particular when the electric machine is operating in field weakening mode.

However, even these previous approaches cannot solve all problems, and so there is still a need for improvements to corresponding electrical and/or electronic systems.

An object of the present disclosure is to enable safe operation and particularly simple, efficient and safe repairability of an electric motor vehicle.

This object is achieved by the subject matter disclosed herein. Further possible configurations of the present disclosure are disclosed in the description and the figures. Features, advantages and possible configurations outlined as part of the description should be regarded, at least analogously, as features, advantages and possible configurations of the respective subject matter of the other parts of the present disclosure and of each possible combination of the subject matter disclosed herein, if necessary in conjunction with each other.

The power electronics unit according to the present disclosure is intended, i.e. appropriately configured and designed, for supplying power to a permanently excited synchronous machine (PSM). The power electronics unit has power semiconductors, or power semiconductor switches, for providing an AC voltage at the output, in particular for converting a DC voltage applied at the input into an AC voltage at the output. In addition, the power electronics unit has electrical external contacts for electrically connecting stator windings of the respective PSM, which are able to be supplied with the AC voltage via the external contacts. An electrical connection within the power electronics unit can therefore run from the power semiconductors to the external contacts. Furthermore, the power electronics unit comprises a filter circuit for filtering the AC voltage, or AC current that accordingly flows via the external contacts during operation. The filter circuit is at a spatial distance from the power semiconductors and is electrically connected between the power semiconductors and the external contacts.

According to the present disclosure, the power electronics unit also comprises a pyrotechnic disconnect unit or disconnect device which is arranged in the filter circuit, or integrated in the filter circuit. The disconnect unit is configured and arranged to physically break, within the disconnect unit, the electrical connection between the external contacts and the power semiconductors which runs through the filter circuit and the disconnect unit. For this purpose, when the disconnect unit is tripped, a piston or disconnect element can be suddenly accelerated, for example by gas pressure, such that it completely severs a relevant electrical conductor, i.e. for example a cable or busbar or the like. In particular, the resulting free ends of the electrical conductor can be electrically isolated from each other by the piston, or disconnect element. The pyrotechnic disconnect unit allows very fast and safe, or reliable, interruption of the electrical connection between the external contacts and the power semiconductors and, when the power electronics unit is used as intended, thus also interruption of the electrical connection between the power semiconductors and the respective PSM, or the stator thereof. However, unlike a conventional switch, this interruption is not reversible. In order to restore the electrical connection, therefore, the disconnect unit must be replaced, for example.

In previous electric drive systems, AC or DC disconnect switches can, for example, be integrated directly in the electronics of an inverter or in a battery controller. This can mean that, during or after a malfunction, the inverter or the battery controller, for example, must accordingly be completely opened to allow repair, which can be costly and carries the risk of damage to surrounding, highly sensitive parts, or electronic components.

The present disclosure can remedy this situation at least to a degree. By arranging the disconnect unit in or on the filter circuit, the disconnect unit is spatially remote from typically particularly sensitive electronic components, such as for example the power semiconductors. The filter circuit, on the other hand, may, for example, be designed as a comparatively robust, i.e. less sensitive, electrical, in particular discrete, circuit. This reduces the risk of secondary damage during repair, i.e. for example when replacing the disconnect unit. If damage were still to occur, it may thus also be able to be repaired at lower cost, as the filter circuit often comprises only comparatively inexpensive and/or individually replaceable electrical components. Overall, placing the disconnect unit outside of particularly sensitive electronic components, or at a distance therefrom, as proposed here, can thus provide improved protection for the rest of the power electronics unit and/or other components of an electrical system in which the power electronics unit in the respective application is incorporated.

In one possible configuration of the present disclosure, the disconnect unit is, or forms, a separate coherent assembly; in other words, the disconnect unit can thus be handled as a discrete assembly or unit separately from the rest of the power electronics unit. This makes it particularly easy to install the disconnect unit in the power electronics unit or to remove it therefrom, for example. The disconnect unit can therefore be replaced quickly and easily.

In a possible development of the present disclosure, the disconnect unit is mounted on the filter circuit, or the rest of the filter circuit, such that it is reversibly detachable without damage. For example, the disconnect unit can be mounted on a carrier or busbar of the filter circuit. In particular, the disconnect unit can be mounted by one or more screw connections. This allows the disconnect unit to be replaced easily, quickly, and without damage or impairment to the filter circuit or the rest of the power electronics unit, for example after tripping. In order to restore the power electronics unit to a fully operational state after the disconnect unit has been tripped, the disconnect unit can thus be replaced individually in this case and it is not necessary to replace the entire power electronics unit, for instance. In addition, the risk of damage to other components of the power electronics unit during replacement of the disconnect unit can be kept particularly low in this case. Mounting the disconnect unit using screw connections, i.e. by one or more screws, also allows the disconnect unit to be replaced by widely available tools that can be used comparatively simply and with a low susceptibility to error. This means that, for example, no special tools are then required for replacing the disconnect unit, and so the disconnect unit can be replaced inexpensively and, if necessary, at least virtually independently of location.

In a further possible configuration of the present disclosure, the power electronics unit has a housing in which the filter circuit and the power semiconductors are received. This housing in turn has an opening covered by a cover element which is reversibly detachable without damage. Such a cover element can therefore be, for instance, a cap or flap or the like. With the cover element open or removed, the filter circuit is accessible through the opening for replacement of the disconnect unit, while at the same time the power semiconductors are, or remain, covered by another region of the housing, i.e. for example a region adjoining the opening. In other words, the surface area of the opening can thus cover at least mainly or only the filter circuit or only a portion of the filter circuit, but not the power semiconductors. The opening, or the cover element, can thus serve as a maintenance or repair access specifically for the disconnect unit, or replacement thereof. Since, in this case, even with the cover element open or removed, the power semiconductors — and, if applicable, further components of the power electronics unit which are arranged in the surroundings of the power semiconductors and/or the filter circuit — remain covered by the housing, or a side of the housing on which the opening is also located, the risk of damage to the power semiconductors or, if applicable, to the other surrounding components when replacing the disconnect unit can be minimized. This allows particularly simple, low-effort and safe replacement of the disconnect unit. This can benefit safety and cost efficiency and be particularly resource-efficient.

In a possible development of the present disclosure, the cover element is mounted on the housing by one or more screw connections, i.e. by one or more screws. In particular, the cover element can be mounted on the housing exclusively using this screw connection or these screw connections. For example, corresponding screw threads can be arranged in the housing immediately next to or around the opening. The development proposed here allows the cover element to be removed particularly easily and then mounted on the housing again, for example after the disconnect unit has been replaced. In addition, the cover element can be held on the housing reliably and securely in this case.

In a possible development of the present disclosure, a seal surrounding the opening is arranged between the housing and the cover element. This allows the opening, or an interior of the housing, to be sealed off from the surroundings, i.e. for example against the ingress of dust, dirt and/or moisture into the power electronics unit. This allows safe and reliable operation of the power electronics unit even under possibly adverse conditions in the surroundings, despite the easy accessibility of the disconnect unit. The seal can, for example, be a flat seal or a profile or lip seal or the like. In particular, the seal can be implemented by way of a discrete seal component, i.e. for example a rubber ring or the like. This is in contrast to a sealing compound, for example. This means that even if the cover element is repeatedly opened or removed and reattached, the seal can be maintained and the effort required to replace the disconnect unit can be kept to a minimum.

The present disclosure also relates to a drive device that may be intended or designed in particular for a motor vehicle. The drive device according to the present disclosure comprises the power electronics unit according to the present disclosure, a permanently excited synchronous machine electrically connected to the external contacts thereof, and a control circuit, or control device. The control circuit or control device is configured to automatically trip the disconnect unit to cut the electrical connection between the external contacts and the power semiconductors in response to a predefined accident signal. Such an accident signal can be, for example, an electrical or electronic signal from an accident sensor, which can be received by the control device via an appropriate interface or line. Similarly, the control device itself can, for example, comprise an accident sensor, i.e. it can be configured to detect an accident, for example involving the respective motor vehicle equipped with the drive device. Similarly, the accident sensor itself can, if necessary, form the control circuit such that a sensor signal emitted by the accident sensor when an accident is detected can directly trip the disconnect unit. The control circuit or control device may be a separate assembly or combined or integrated in or with other components and/or functions. For example, the control circuit or control device may be combined in the power electronics unit or with a control system for the synchronous machine.

The present disclosure also relates to a motor vehicle comprising the drive device according to the disclosure and a high-voltage storage device, i.e. a high-voltage secondary battery. The high-voltage storage device is connected to an input, i.e. electrical input connections, of the power electronics unit of the drive device and is configured to provide DC voltage to the power electronics unit via this input. In other words, the drive device can thus be supplied with energy from the high-voltage storage device in this case. Conversely, it may also be possible for the drive unit to operate as a generator to charge the high-voltage storage device. In particular, the motor vehicle can also have an accident sensor for generating the accident signal mentioned in connection with the drive device according to the present disclosure when an accident involving the motor vehicle is detected, for example as a separate component connected to the drive device or as part of the drive device. The motor vehicle according to the present disclosure can, in particular, be the motor vehicle mentioned in connection with the power electronics unit according to the present disclosure and/or the drive device according to the present disclosure.

Further features of the present disclosure can be found in the figures and the description of the figures. The features and combinations of features mentioned above in the description, and the features and combinations of features shown below in the description of the figures and/or in the figures alone, can be used not only in the combination specified in each case, but also in other combinations or on their own, without departing from the scope of the present disclosure.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a sectional schematic perspective representation of a power electronics unit with the maintenance cap closed;

FIG. 2 shows a sectional schematic perspective representation of the power electronics unit with the maintenance cap open;

FIG. 3 shows a sectional schematic perspective representation of a filter circuit of the power electronics unit comprising an integrated pyrotechnic disconnect unit;

FIG. 4 shows a sectional schematic perspective representation of the power electronics unit with the maintenance cap open and the pyrotechnic disconnect unit removed for replacement; and

FIG. 5 shows a sectional schematic representation of a motor vehicle comprising the power electronics unit.

### DETAILED DESCRIPTION OF THE DRAWINGS

In the figures, identical elements and elements with the same function are provided with the same reference signs. For the sake of clarity, at least in some cases, only a representative selection of identical or similar elements that appear multiple times is explicitly marked in the figures.

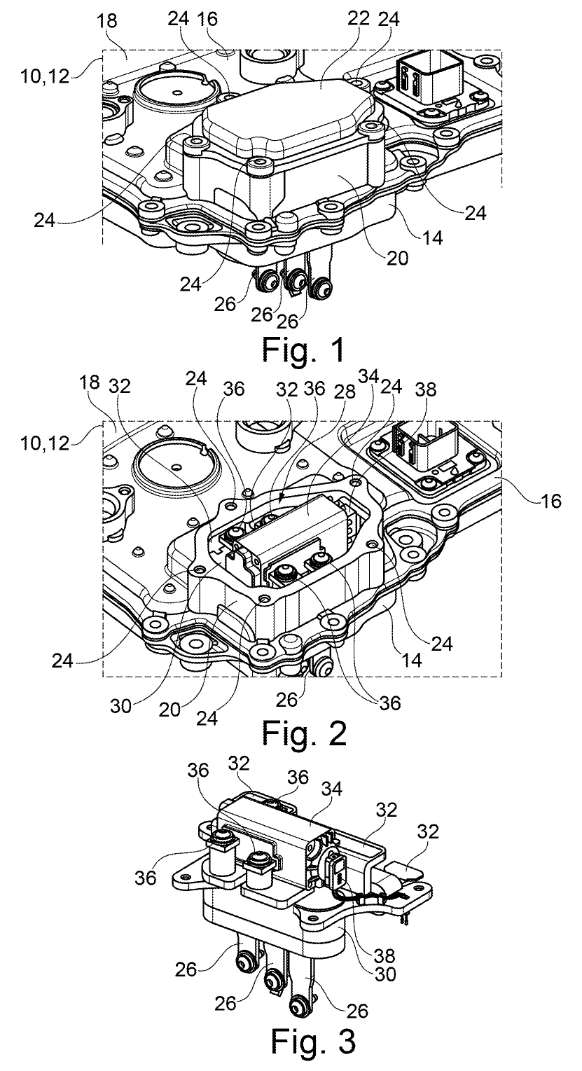

FIG. 1 shows a sectional schematic perspective representation of a power electronics unit 10 with a housing 12 in which various electrical and electronic components are received. The housing 12 here comprises a housing lower part 14 and a housing upper part 16, which are connected to each other and form, or surround, an interior of the housing 12. Components assigned to different functions of the power electronics unit 10 can be arranged in different regions or groups. The housing 12 can then, for example, have appropriate molded features at a spatial distance from each other to encompass or receive these regions or groups of components. By way of example, the electronics unit 10, or the housing 12, has an electronics region 18 and a filter region 20. Power semiconductors for converting a DC voltage at the input into an AC voltage at the output can, for example, be arranged in the electronics region 18. A filter circuit 30 (see FIG. 2) for filtering the AC voltage, or a corresponding AC current, can be received in the filter region 20.

The housing 12 here comprises a maintenance cap 22 as a cover for the filter region 20. This maintenance cap 22 is connected, for example screwed, to the rest of the housing upper part 16 at mounting points 24. The maintenance cap 22 can thus be detached from the rest of the housing upper part 16 to provide access to components of the power electronics unit 10 that are arranged therebelow, i.e. in the filter region 20.

The output side of the power electronics unit 10 has a plurality of electrical external contacts 26. These external contacts 26 can be electrically connected to the filter circuit 30 and, via the filter circuit, to the power semiconductors. The filtered AC voltage can therefore be provided at the external contacts 26. When the power electronics unit 10 is used as intended, for example in a motor vehicle 40 (see FIG. 5), the external contacts 26 can be connected, for example, to stator windings of a permanently excited synchronous machine, i.e. a PSM 44 (see FIG. 5).

To protect the PSM 44 in the event of an accident involving the motor vehicle 40, the stator of the PSM 44 should be electrically disconnected from a supplying inverter, i.e. in this case in particular from the power semiconductors of the power electronics unit 10. This is because, for example, if the motor vehicle 40 coasts to a standstill after an accident or if the motor vehicle 40 is towed away, the permanent magnets of the PSM 44 can generate unwanted electricity. However, after such a situation, it should not be necessary to replace the entire power electronics unit 10, and repairs should be as simple, quick and safe as possible to carry out.

To illustrate a solution to these challenges, FIG. 2 shows a sectional schematic representation of the power electronics unit 10 with the maintenance cap 22 open, or removed. This means that a maintenance opening 28 of the housing 12, or of the housing upper part 16, which can be covered by the maintenance cap 22, is thus uncovered here. Accordingly, part of the filter circuit 30 is visible here, i.e. accessible through the maintenance opening 28. However, even with the maintenance cap 22 open or removed, the power semiconductors in the electronics region 18 are still covered by the housing upper part 16.

While the output side of the filter circuit 30 is electrically connected to the external contacts 26, the input side of the filter circuit 30 can be connected to electrical internal contacts 32. These internal contacts 32 can form electrical connections to the power semiconductors in the electronics region 18 and/or to further and/or other components of the power electronics unit 10.

In order to achieve the described disconnection of the PSM 44 from the power semiconductors of the power electronics unit 10 in the event of an accident, i.e. in the event of a crash, the power electronics unit 10 comprises a pyro separator, i.e. a pyrotechnic disconnect unit 34. This disconnect unit 34 is integrated in the filter circuit 30, or mounted on the filter circuit 30, here. In this case, the disconnect unit 34 is mounted as a separate assembly on the filter circuit 30, or the rest of the filter circuit 30, by screws 36. These screws 36 can therefore be detached when the maintenance cap 22 is open, or removed, in order to remove the disconnect unit 34. Accordingly, a new disconnect unit 34 can then be inserted and mounted again by the screws 36. The maintenance cap 22 can then be placed back onto the maintenance opening 28 and mounted on the housing upper part 16 to close the maintenance opening 28 again.

For further illustration, FIG. 3 shows a schematic perspective representation of the filter circuit 30 with the external contacts 26, the internal contacts 32 and the disconnect unit 34. A control contact plug 38 connected to the disconnect unit 34 is also visible here. This control contact plug 38 can be connected to a control circuit or a control device or, for example, directly to an accident sensor. A signal for tripping the disconnect unit 34 can be sent thereto via an appropriate connection, or the control contact plug 38. Thus, when tripped in this way, the disconnect unit 34 can then interrupt, or cut, the electrical connection between the power semiconductor and the external contacts 26. To replace the disconnect unit 34, it is possible, in addition to detaching the screws 36, to also remove the control contact plug 38 from the disconnect unit 34 and later plug it into the newly inserted disconnect unit 34.

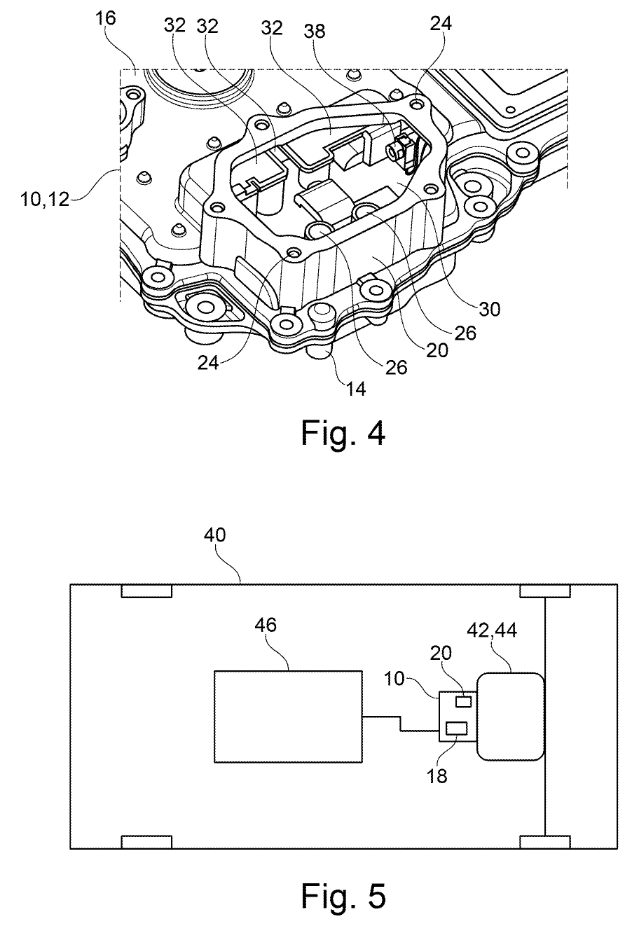

For further illustration, FIG. 4 shows a sectional schematic representation of the power electronics unit 10 with the maintenance cap 22 open, or removed, and the disconnect unit 34 removed.

FIG. 5 shows a sectional schematic representation of the motor vehicle 40. The motor vehicle 40 has a drive device 42, which comprises the PSM 44 and the power electronics unit 10. To supply power to the drive unit 22, the motor vehicle 40 also has a high-voltage storage device 46. Here, the input side of said high-voltage storage device can be electrically connected to the power electronics unit 10, in particular to an input of the power semiconductors arranged in the electronics region 18, or to a corresponding power semiconductor module or inverter module.

Overall, the examples described show how, in the case of an electric motor, a pyro disconnect element can be integrated into an AC filter so as, by virtue of this placement outside of sensitive electronic components, to improve the protection of a remaining portion of an inverter and allow easy maintenance.

The foregoing disclosure has been set forth merely to illustrate the present disclosure and is not intended to be limiting. Since modifications of the disclosed embodiments incorporating the spirit and substance of the present disclosure may occur to persons skilled in the art, the present disclosure should be construed to include everything within the scope of the appended claims and equivalents thereof.

### LIST OF REFERENCE SIGNS

10 Power electronics unit

12 Housing

14 Housing lower part

16 Housing upper part

18 Electronics region

20 Filter region

22 Maintenance cap

24 Mounting points

26 External contacts

28 Maintenance opening

30 Filter circuit

32 Internal contacts

34 Disconnect unit

36 Screws

38 Control contact plug

40 Motor vehicle

42 Drive device

44 PSM

46 High-voltage storage device

What is claimed is:

1. A power electronics unit for a permanently excited synchronous machine comprising:
power semiconductors configured to provide an AC voltage;
external contacts configured to electrically connect stator windings of the respective permanently excited synchronous machine, which are configured to be supplied with the AC voltage via the external contacts;
a filter circuit that is arranged at a spatial distance from the power semiconductors and is electrically connected between the power semiconductors and the external contacts, and is configured to filter the AC voltage; and
a pyrotechnic disconnect unit that is integrated in the filter circuit and is configured to physically break, within the disconnect unit, an electrical connection between the power semiconductors and the external contacts that runs through the filter circuit and the disconnect unit.

2. The power electronics unit according to claim 1,
wherein the disconnect unit forms a separate coherent assembly.

3. The power electronics unit according to claim 1,
wherein the disconnect unit is mounted on the filter circuit such that it is reversibly detachable without damage.

4. A power electronics unit comprising:
a housing in which a filter circuit and power semiconductors are received, wherein the housing comprises an opening covered by a cover element that is reversibly detachable without damage, through which opening, with the cover element removed, the filter circuit is accessible for replacement of a disconnect unit while the power semiconductors remain covered by another region of the housing.

5. The power electronics unit according to claim 4,
wherein the cover element is mounted on the housing by one or more screw connections.

6. The power electronics unit according to claim 4, comprising:
a seal surrounding the opening arranged between the housing and the cover element.

7. A drive device comprising:
the power electronics unit according to claim 1;
a permanently excited synchronous machine electrically connected to the external contacts of the the power electronics unit; and
a control device configured to automatically trip the disconnect unit in response to a predefined accident signal.

8. A motor vehicle comprising:
the drive device according to claim 7; and
a high-voltage storage device configured to provide DC voltage to an input of the power electronics unit of the drive device.
